(19) United States
(12) Patent Application Publication
(10) Pub. No.: US 2020/0391551 A1
(43) Pub. Date: Dec. 17, 2020

(54) NON-PNEUMATIC SUPPORT STRUCTURE

(71) Applicant: Michael Stephan Overholt, San Jose, CA (US)

(72) Inventor: Michael Stephan Overholt, San Jose, CA (US)

(21) Appl. No.: 16/732,223

(22) Filed: Dec. 31, 2019

Related U.S. Application Data
(63) Continuation of application No. 16/438,452, filed on Jun. 11, 2019, now abandoned.

(51) Int. Cl. B60C 7/14

(52) U.S. Cl. CPC B60C 7/14

(57) ABSTRACT

A non-pneumatic support structure for a wheel having an axis of rotation for use in tires and wheel assemblies for a vehicle is provided. The non-pneumatic support structure includes one or more anisotropic parabolic discs. The one or more anisotropic parabolic discs are configured to allow deformation parallel to an axis of rotation of the wheel with the ground and to substantially favor lateral deformation over radial deformation. The non-pneumatic support structure may be incorporated into a tire, or an indivisible tire and wheel assembly. A tire or tire and wheel assembly incorporating a non-pneumatic support structure includes a radial ground contacting tread. Further, a tire or tire and wheel assembly incorporating a non-pneumatic support structure will deform parallel to the axis of rotation in response to impact, load or shear to increase the area of the ground contacting tread in contact with the ground.

### CROSS-REFERENCES TO RELATED APPLICATION

This application claims the benefit of U.S. Provisional Application No. 62/834,960 filed Apr. 17, 2019, which is incorporated herein by reference in its entirety. This is a continuation of application Ser. No. 16/438,452 filed with title “NON-PNEUMATIC SUPPORT STRUCTURE” and naming as inventor Michael Overholt, the entire content of which is incorporated herein by reference in entirety.

### TECHNICAL FIELD

The present disclosure generally relates to tires, and tire and wheel assemblies for vehicles, and particularly relates to non-pneumatic tires, and non-pneumatic tire and wheel assemblies for vehicles.

### BACKGROUND

Pneumatic tires have been implemented for on-road and off-road vehicles for over a century. The conventional pneumatic tire is a tensile structure that is characterized by a toroidal morphology with ground-contacting annular tread and a pressurized air cavity. As such the pneumatic tire requires internal air pressure in the tire cavity to maintain its mechanical attributes. Reaction to the inflation pressure provides correct rigidities to the belt and carcass components. However, careful pressure maintenance is required to obtain the best performance from a pneumatic tire. Inflation pressure below that specified for safe use results in higher rolling resistance, higher operating temperature and the potential for mechanical failure. Further, conventional pneumatic tires are of very limited use after a complete loss of inflation pressure. Also, conventional pneumatic tires contribute a substantial carbon footprint over their lifecycle. It has been found that rolling resistance in pneumatic tires accounts for between 5 and 30 percent of vehicles fuel consumption. In addition, pneumatic tires whose tread has worn out or punctured often cannon be safely returned to service through tread replacement so must be buried, recycled, or burned. Recycling is both energy and waste intensive. Burning tires as a cheap replacement for coal produces large amounts of CO2, and photochemical smog.

Non-pneumatic tires are also known in the art. Non-pneumatic tires whether solid or supported by elastomeric structures have historically been designed with a similar toroidal morphology and annular tread. Non-pneumatic tires are designed without internal air pressure, thus requiring no pressure maintenance. As such non-pneumatic tires may eliminate many of the problems and compromises associated with a pneumatic tire. However, such structurally supported tires have historically been unable to provide same level of performance as pneumatic tires.

Toroidal tires, whether pneumatic or non-pneumatic have an annular and roughly cylindrical tread portions which contact the driving surface with an area that is determined by the resistance of the sidewall and tread to deformation under load. Greater resistance to deformation generally reduces rolling resistance at the cost of a less compliant tire, increased vibration, less tread contact with the driving surface and less traction under most driving conditions. Compromises including improved formulation of the tread and underlying annular layers have improved traction for smaller areas of tread contact generally at the cost of increased rolling resistance and increased susceptibility to wear.

Toroidal tires with their single, near planar annular tread have a nearly invariant area of tread contact with the driving surface regardless of the driving condition. As such the area of tread contact, or “patch” is constrained by the stiffness of the sidewall and tread. Under conditions when the vehicle is neither turning, accelerating, or decelerating, that is when shear and traction demands are low, the tread patch is nearly the same area as when the tire is subjected to high shear conditions, such as in a high-speed turn or panic stop. In other words, the virtually the entire annular tread and shear band are exposed to wear at all times, with every rotation of the tire, regardless of operating conditions. This constrains the compounding and structure of the tread and shear band to be fabricated to wear uniformly throughout. As such, toroidal tires are generally constrained from applying more than one tread compound, and therefore one level of cushioning and traction in contact with the driving surface.

Further, toroidal tire's single load-bearing annular tread undergoes deformation predominantly in the direction perpendicular to the axis of rotation in response to impact with protrusions in the driving surface. Even small protrusions relative to the diameter of the tire can induce a vertical impulse to the entire tire and wheel which transmits vibration and audible noise into the vehicle cabin.

Furthermore, the annular tread of toroidal tires with near planar, often near-rectangular contact area and rising leading edge, are prone to aquaplaning when the tire encounters pavement covered with a film of water. Such aquaplaning can cause sudden unsafe loss of directional control. Improved tread designs incorporating thin circumferential areas of removed tread grooves have been implemented to provide channels for displaced water may allow the protruding tread to remain in contact with the driving surface to improve wet traction. However, they do so by reducing the area of contact, thereby compromising traction on dry surfaces. It may be understood that in such tires, the depth of the groove, providing the channel, cannot exceed that of the tread that is grooved, and thus such grooves can be rendered ineffective against aquaplaning by water level with depth exceeding the thickness of the tread.

Prior art in the field of tires, both pneumatic and non-pneumatic is predominantly exemplified by four readily discernible characteristics which are eliminated in the present disclosure: (1) toroidal morphology, (2) single annular ground-contacting tread, (3) near-invariant area of tread in contact with the ground under varying levels of shear, and (4) elastic deformation primarily perpendicular to the axis of rotation in response to impact or shear. Prior attempts to design non-pneumatic tires provide characteristics competitive with pneumatic tires that have focused on structural improvements to provide rigidity using elastic materials and fibers without increasing weight have met with little success. For instance, U.S. Pat. No. 3,163,199A (N. P. s. Straussler, 1964) discloses a vehicle wheel having two or more support members with annular/circumferential tread supported by spring rings which unlike the present invention, elastically deforms primarily in the direction perpendicular to the axis of rotation in contact with the ground. U.S. Pat. No. 4,921,029A discloses a trapezoidal non-pneumatic tire with supporting and cushioning members. U.S. Pat. No. 5,685,926A discloses a non-pneumatic tire with toroidal morphology with a single annular tread supported by a plurality of curved or parabolic support members and enclosed gas-filled cells. U.S. Pat. No. 9,511,632B2 discloses a non-pneumatic tire with toroidal morphology composed of multiple elastic plates and single annular tread. US Patent Publication Number 20160280005A1 discloses a non-pneumatic wheel with reduced lateral stiffness having toroidal morphology with single annular tread supported by a plurality of angled elastic spokes acting as springs. US Patent Publication Number 20170355233A1 discloses a tire with concave sidewalls having toroidal morphology with sidewalls designed to fold under compression with a single annular tread. US Patent Publication Number 20170157983A1 discloses a non-pneumatic tire with toroidal morphology with a single annular ground-contacting tread a shear band and a connected spoke disk. US Patent Publication Number 20170080756A1 discloses a non-pneumatic structurally supported tire with toroidal morphology including a single ground contacting annular tread portion, an annular shear band and two or more spokes. US Patent Publication Number 20170174005A1, (P. C. Van Riper, 2017) discloses a non-pneumatic structurally supported tire with toroidal morphology including a single ground contacting annular tread portion, an annular shear band and at least one parabolic spoke disk extending between an outer ring containing the annular ground-contacting tread and shear band, and an inner ring. Unlike the present invention, in Van Riper the outer end(s) of the parabolic disc(s) are attached to an outer ring with shear band and single annular tread. Consequently, the parabolic spoke(s) are constrained by the outer ring, attached shear band and tread to elastically deform primarily perpendicular to the axis of rotation and the tread “patch” or “footprint” is placed in contact with the ground on every revolution of the tire. Unlike the present invention, the aforementioned disclosed tire, or tire and wheel assemblies are designed to apply a near-constant annular/circumferential tread area in contact with the ground and/or elastically deform primarily in the direction perpendicular to the axis of rotation, which is undesirable.

Therefore, there is a need for addressing the problem associated with the prior-art and provide a non-pneumatic support structure for tires and tire and wheel assemblies with a novel non-toroidal morphology that can provide performance competitive with pneumatic tires without requiring an air bladder, while minimizing rolling resistance and reducing life-cycle energy consumption and waste production through reuse without compromising safety.

### SUMMARY OF THE EMBODIMENTS

Various aspects and embodiments of the present disclosure provide a non-pneumatic support structure for wheels of a vehicle.

In the present disclosure, a non-pneumatic support structure for tires, and tire and wheel assemblies in vehicles is disclosed. In one aspect of the present disclosure a non-pneumatic tire that incorporates a non-pneumatic support structure adapted to be mounted on a conventional wheel or rim of a vehicle is disclosed. In another aspect of the present disclosure, a non-pneumatic wheel and tire assembly that incorporates a non-pneumatic support structure adapted to be mounted on a conventional axle hub of a vehicle is disclosed. In embodiments of the present disclosure, the non-pneumatic support structure includes one or more parabolic discs.

In one or more embodiments, the one or more parabolic discs are flexible anisotropic parabolic discs composed of elastomeric material.

In one or more embodiments, the one or more parabolic discs are fabricated to elastically deform parallel to the axis of rotation in the direction of the concave side of the parabola.

In one or more embodiments, the anisotropy of flexural modulus of the one or more parabolic discs is defined such that elastic deformation parallel to the axis of rotation is substantially favored over deformation perpendicular to the axis of rotation.

In one or more embodiments, the flexural modulus for deformation parallel to the axis of rotation is chosen to support the vehicle load on the wheel with the band of tread on the outer circumference of the parabola under static load.

In one or more embodiments, the wheels and/or tire assemblies include a ground-contacting tread area on the convex side of the parabola. Further, the flexural modulus for deformation parallel to the axis of rotation is chosen to support the vehicle load on the wheel with the entire tread area under conditions of high shear.

Other aspects and example embodiments are provided in the drawings and the detailed description that follows.

### BRIEF DESCRIPTION OF DRAWINGS

For a more complete understanding of example embodiments of the present technology, reference is now made to the following descriptions taken in connection with the accompanying drawings in which:

FIG. 1 illustrates a diagrammatic perspective side view of a non-pneumatic tire incorporating a two-disc non-pneumatic support structure, in accordance with one or more embodiments of the present disclosure;

FIGS. 2A-2C illustrate diagrammatic planar front views of a tire incorporating a two-disc non-pneumatic support structure under increasing load, impact or shear from FIG. 2A to 2C, in accordance with one or more embodiments of the present disclosure;

FIG. 3 illustrates a diagrammatic perspective side view of an indivisible tire and wheel assembly incorporating a two-disc non-pneumatic support structure adapted to be mounted on a vehicle hub, in accordance with one or more embodiments of the present disclosure;

FIG. 4 illustrates a diagrammatic perspective side view of a non-pneumatic tire incorporating a four-disc non-pneumatic support structure adapted to be mounted on a vehicle wheel, in accordance with one or more embodiments of the present disclosure;

FIGS. 5A-5C illustrate diagrammatic planar front views of a four-disc non-pneumatic support structure under increasing load, impact or shear from FIG. 5A to 5C, in accordance with one or more embodiments of the present disclosure;

FIG. 6 illustrates a diagrammatic perspective side view of an an indivisible tire and wheel assembly incorporating the four-disc non-pneumatic support structure adapted to be mounted on a vehicle hub, in accordance with one or more embodiments of the present disclosure;

FIG. 7 illustrates diagrammatic left and right perspective side views of an unloaded indivisible tire and wheel assembly incorporating a two-disc non-pneumatic support structure, in accordance with one or more embodiments of the present disclosure; and

FIG. 8 illustrates a partial diagrammatic perspective side view of a two-disc non-pneumatic support structure installed on a right-front side of a vehicle, with tread shown on the exposed convex side of left parabolic disc thereof, in accordance with one or more embodiments of the present disclosure.

FIG. 9 illustrates a schematic cutaway interior view of an exemplary composite layup of a single anisotropic parabolic disc non-pneumatic support structure.

The drawings referred to in this description are only exemplary in nature and shall not be construed as limiting the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced with details other than these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

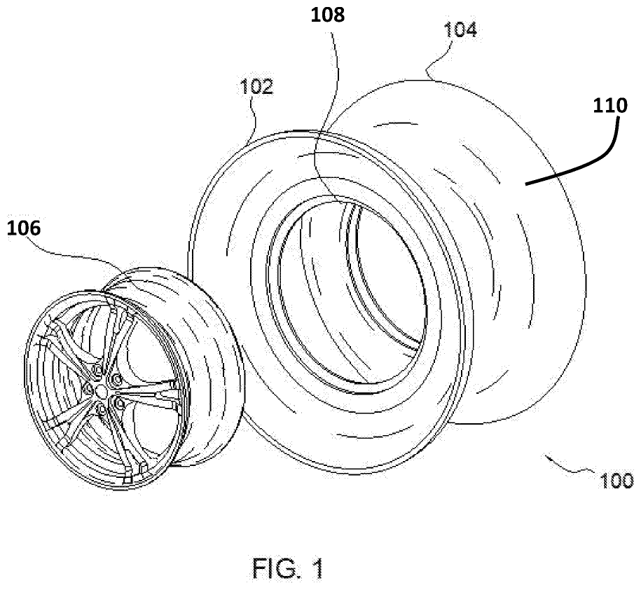

Referring to the drawings, FIG. 1 illustrates a schematic perspective side view of an exemplary embodiment of an unloaded two-disc non-pneumatic support structure (generally designated by the numeral 100), in accordance with one or more embodiments of the present disclosure. The non-pneumatic support structure 100 is adapted for mounting on a conventional wheel fabricated for pneumatic tires. Herein, the non-pneumatic support structure 100 may be mounted on a wheel or rim of a wheel used in the vehicle, and in turn support wheel therein (as discussed in the proceeding paragraphs with reference to the accompanied drawings). It may be contemplated by a person skilled in the art that the non-pneumatic support structure 100, as illustrated and disclosed herein, may generally be similar in design as a non-pneumatic tire or a non-pneumatic wheel and tire assembly for use in a vehicle, and the terms have been interchangeably used (like, non-pneumatic tire 100) without departing from the scope of the present disclosure.

Herein afterwards, the term “unloaded” is defined as unstressed and supporting no weight; the term “static load” is defined as the fractional weight of an unmoving vehicle supported by one tire and wheel; the term “lateral” is defined as parallel to the axis of rotation, i.e. horizontally; the terms “vertical”, “radial” and “diametric” are defined as perpendicular to the axis of rotation; t the terms “wheel” and “rim” refer to the rigid circular object to which a tire may be affixed which may be attached to an axle “hub” below a vehicle; the term “inward” is defined as parallel to the axis of rotation toward the vertical center of the wheel; the term “outward” is defined as parallel to the axis of rotation away from the vertical center of the wheel; the term “ride height” is defined as distance between the rim flange and the ground; and the term “patch” is defined as the area of tread in contact with the ground.

The non-pneumatic support structure 100 includes one or more anisotropic elastomeric parabolic discs. As illustrated in FIG. 1, the non-pneumatic support structure 100 includes two parabolic discs, a first parabolic disc 102 and a second parabolic disc 104 adapted to be suitable for mounting on a vehicle wheel as a replacement for a conventional tire or the like. The parabolic discs 102 and 104 are joined in this example by an by attachment to a conventional pneumatic vehicle rim 106. The parabolic disks 102 and 104 may be secured to the rim using an adhesive, a slotted mating surface that grips both sides of the rim flanges tightly by compressive tension, an expanded bead similar to current pneumatic tire beads or any other method alone or in combination with the aforementioned that provides sufficient strength and support. The parabolic discs 102 and 104 are dynamic structural supports that prevent a wheel or a hub from making contact with the ground analogous to the sidewalls of a conventional pneumatic tire. Contrary to a pneumatic tire or solid non-pneumatic tire with annular tread in which the entire tire acts as a single supporting and cushioning member, the parabolic discs 102 and 104 can act semi-independently to support the wheel or hub.

In embodiments of the present disclosure, the parabolic discs 102 and 104 are flexible anisotropic parabolic discs composed of elastomeric material. In the present implementation, “parabolic” is defined for an unloaded disc in which the extent of the solid diametric cross-section of the non-pneumatic support structure 100 approximates an ideal two-dimensional (2D) parabola described by standard notation:

y=ax²+bx+c,

wherein 0.001≤a≤0.05, b=0, c=0, and wherein the axis of rotation is the axis of symmetry. Further, “disc” is defined as a thin circular object. Further, “anisotropic” is defined using the standard notation as favoring deformation increasing the positive coefficient of the quadratic term x2 over deformation of the circular perimeter of the disc.

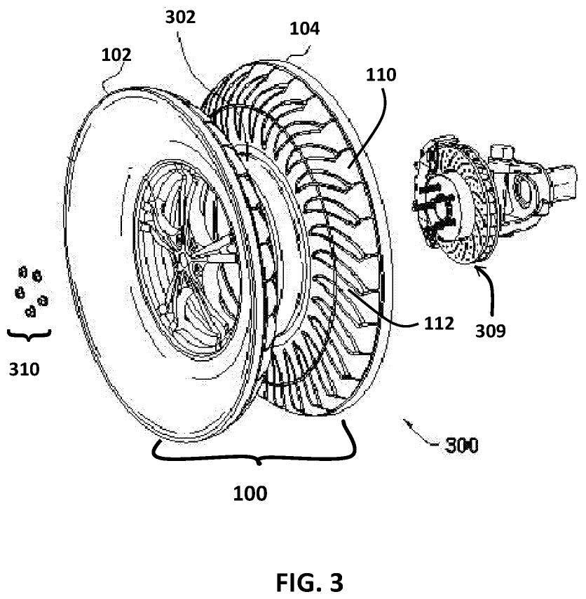

Further, as illustrated in FIG. 1, the non-pneumatic support structure 100 further includes a circular hole 108 sized appropriately to allow installation thereof on a wheel 106. In the present embodiments, as may be contemplated and appreciated by a person skilled in the art, the material on the circumference in proximity to the circular hole 108 may be fabricated to be elastically deformable to facilitate installation on a wheel/rim. In one implementation of the present disclosure, the parabolic discs 102 and 104 with the ground contacting tread 110 on the inward or convex side (as discussed in the preceding paragraphs, properly shown in FIG. 3) are adapted to support the wheel thereon, and is mounted on a wheel as a non-pneumatic tire. In another embodiment of the present disclosure, the parabolic discs 102 and 104 with ground contacting tread 110 are integrated with a wheel/rim in an indivisible non-pneumatic tire and wheel assembly which is adapted to be mounted on and support an axle hub for mounting of the tire and wheel assembly thereon.

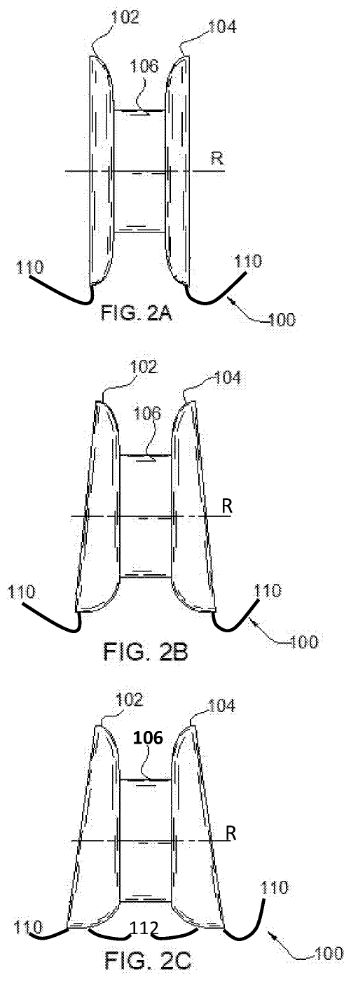

In a non-pneumatic tire (incorporating the non-pneumatic support structure 100), any load is supported by bands of ground contacting treads 110 (as properly shown and labelled in FIGS. 2A-2C) on outer circumferences of the parabolic discs 102 and 104. The ground contacting tread 110 is secured to the convex side of the respective parabolic discs 102 and 104. Generally, the tread 110 is the layer between the parabolic discs 102 and 104 and the driving surface and present a conformal, high-friction layer to the driving surface (as known in the art). Any combination of natural and engineered elastomers and high-strength fiber known to a person skilled in the art may be chosen to create a flexural modulus of the parabolic discs 102 and 104 that assures that the area of the tread 110 in contact with the ground is sufficient to carry the static and dynamic loads and shear on the non-pneumatic support structure 100 without exceeding the pressure and shear strength of the individual disc or tread compound or the attachment of the tread to the disc. In the present embodiments, the tread 110 may be permanent tread or removable/replaceable tread suitable for installation on a conventional wheel rim without any limitations.

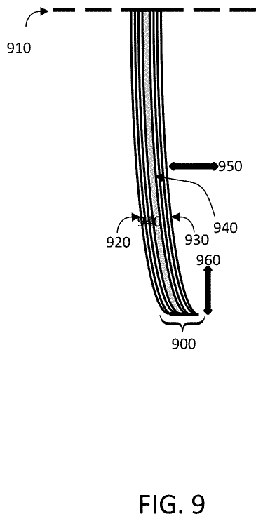

In one or more embodiments, the parabolic discs 102 and 104 are fabricated to be anisotropic, that is, to substantially favor lateral deformation parallel to the axis of rotation over radial deformation of the outer circumference under shear to increase the area of tread 110 in contact with the ground. Any combination of natural and engineered elastomers with high-strength fiber in various useful orientations known to a person skilled in the art may be chosen to create the necessary anisotropy. The parabolic discs 102 and 104 are engineered with a flexural modulus sufficient to support the weight of a vehicle under static and dynamic load with low hysteresis, and high resistance to structural fatigue with minimal weight. The key properties, anisotropy, high strength, tailorable flexural modulus, low hysteresis, high heat and fatigue resistance and light weight may be engineered with composite materials including, but not limited to, glass fiber, graphite fiber, carbon fiber, graphene foam, polyester, steel, Aramid fiber (aka Kevlar™) such as K-49, K-119, or K-129, carbon fiber reinforced polymer (CFRP), Aramid fiber reinforced elastomer (AFRE), Liquid Crystal Polymer (LCP, aka Vectran™), Nomex® honeycomb, polyurethane, engineering polymer blends, natural rubber (NR), synthetic rubber (butadiene rubber etc.), carbon black, silica, and the like. Composite structures are common in transportation applications and their design and fabrication are well understood. Composite structures are routinely used for light-weight, high-strength anisotropic structures. FIG. 9 illustrates a schematic cutaway interior view 900 of an exemplary composite layup of the core of a single anisotropic parabolic disc non-pneumatic support structure. FIG. 9 illustrates an approach to achieving high radial flexural modulus with lower axial flexural modulus to favor deformation parallel to the axis of symmetry over radial deformation in response to stress. Orientation vector 910 is parallel to the axis of rotation and the axis of symmetry of the parabolic structure. The stiffening members 920 and 930 are depicted as 4-ply radially oriented continuous carbon fiber and epoxy resin CFRP lamina in which the radial flexural modulus 960 significantly exceeds the axial flexural modulus 950. Stiffening members 920 and 930 are shown bonded to an AFRE member 940. The radial and axial flexural moduli of a stiffening member are generally proportional to the number of radially oriented continuous fiber (ROCF) plies in the lamina. The axial flexural modulus of an ROCF stiffening member may be increased relative to the radial flexural modulus by incorporating one or more cross-weave or angled plies at up to 90 degrees with the magnitude of increase per ply proportional to the angle of incidence to the radial plies.

Further, in one or more embodiments as in FIG. 1, the compound for the tread 110 may be chosen to vary from the outer circumference toward the axis of rotation. Any combination of natural and engineered elastomers known to a person skilled in the art may be chosen to meet the desired handling and performance requirements. For example, the exterior compound for the tread 110 applied to the outer circumferential band of the parabolic discs 102 and 104 may be chosen to optimize for wear resistance and reduced rolling resistance and the interior compound for the tread 110 may be chosen to progressively optimize for increasing traction radially toward the axis of rotation under various conditions.

In various embodiments, the parabolic discs 102 and 104 support the wheel or hub. As discussed, the non-pneumatic tire may be mounted on a conventional vehicle wheel and the wheel is supported by the flexible parabolic discs 102 and 104 of the non-pneumatic support structure 100. Alternatively, the non-pneumatic support structure 100 (or the wheel assembly) may be integrated with a conventional vehicle wheel in an indivisible tire and wheel assembly adapted to be mounted on an axle hub such that the hub is supported by the flexible parabolic discs 102 and 104. Herein, the parabolic discs 102 and 104 act in the manner of laterally deflecting leaf springs for the wheel. However, as the perimeter of each of the unloaded parabolic discs 102 and 104 is circular, the spring action is confined to a sector of varying central angle from the axis of rotation to the ground. Further, a central angle of the sector and an angle of lateral deformation vary in proportion to a combination of load and sheer. Accordingly, the area of tread 110 in contact with the ground varies in proportion to the following: (a) the angle of lateral deformation of the parabolic discs 102 and 104, (b) the central angle of the supporting sector, and (c) the conformal deformation of the parabolic discs 102 and 104 in contact with the ground.

According to embodiments of the present disclosure, the one or more anisotropic parabolic discs, such as the parabolic discs 102 and 104, are configured to allow deformation parallel to an axis of rotation of the wheel with the ground, to substantially favor lateral deformation to radial deformation of the one or more anisotropic parabolic discs under shear load to increase area of the ground contacting tread in contact with the ground. Herein, a flexural modulus of the parabolic discs 102 and 104 is configured such that elastic deformation parallel to the axis of rotation of the wheel with the ground is substantially favored over deformation perpendicular to the axis of rotation of the wheel with the ground. That is, a flexural modulus of the parabolic discs 102 and 104 is configured to substantially favor lateral deformation to radial deformation of an outer circumference of the parabolic discs 102 and 104 under shear load. The flexural modulus for deformation parallel to the axis of rotation is chosen to support the vehicle load on the wheel with the outer circumference of the parabola of the parabolic discs 102 and 104 under static load. Further, the flexural modulus for deformation parallel to the axis of rotation is chosen to support the vehicle load on the wheel with the entire tread area under conditions of high shear.

It may be appreciated that any suitable method of securing the non-pneumatic support structure 100 to a wheel as known in the art may be implemented without any limitations. Further, the treads 110 may be secured to the respective parabolic discs 102 and 104 by any suitable method known to a person skilled in the art to be of sufficient strength and resilience. For instance, in one example, the non-pneumatic support structure 100 may include a slotted mating surface that tightly grips both sides of the rim flanges by compressive tension. In another example, the wheel mating surface may be configured similarly to tire beads commonly used in pneumatic tires and secured with an adhesive. The treads 110 may be secured permanently such that the parabolic discs 102 and 104 and the treads 110 are formed as an indivisible unit thereof. Alternatively, a person skilled in the art may choose to fabricate a tread-disc interface that allows the treads 110 to be nondestructively removed from the corresponding parabolic discs 102 and 104, and allows new treads to be installed if required (for example, when worn out).

Furthermore, in the present examples, the method of attachment to the wheel is configured to force the parabolic disc 102 and the second parabolic disc 104 into secure contact with the wheel flanges and interior wheel cylinder. The method of attachment and the separation of the parabolic discs 102 and 104 on the wheel and their position with respect to the wheel flanges may be chosen by a person skilled in the art to meet the performance requirements of the application. Further, the diameter of the parabolic discs 102 and 104, and their statically loaded lateral and conformal deflection and ride height may be chosen by a person skilled in the art to meet the performance requirements of the application.

FIGS. 2A-2C are schematic front planar views of the two-disc non-pneumatic support structure 100 (as shown in FIG. 1) under increasing load conditions from 2A to 2C, in accordance with exemplary embodiments of the present disclosure. Herein, the non-pneumatic support structure 100 is adapted to rotate about an axis of rotation ‘R’ (as shown by a dashed line). The illustrated views show an example parabolic contour of the parabolic discs 102 and 104 attached to a vehicle rim 106. As shown, the parabolic discs 102 and 104 form the left and right sides of the non-pneumatic support structure 100, extending radially/transversely from the wheel to the ground. In the present embodiments, the parabolic discs 102 and 104 are arranged with their convex sides facing inward and concave sides facing outward. However, while this arrangement assures that the parabolic discs 102 and 104 may elastically deform laterally without mutual interference, it may not be limiting to the present disclosure. It may be appreciated that the lateral and conformal deformation under load and shear are determined by the flexural modulus and anisotropy chosen for specific instances of the designer's implementation. The deformation of the discs as depicted in the drawings is purely for the purpose of clarifying the operation of the tires and is in no way quantitative or prescriptive of a specific embodiment.

In particular, FIG. 2A illustrates an exemplary embodiment of the two-disc non-pneumatic support structure 100 in an unloaded condition. Further, FIG. 2B illustrates an exemplary embodiment of the two-disc non-pneumatic support structure 100 under static load. As depicted, the parabolic contour of the parabolic discs 102 and 104 is generally maintained with minimal deformation (for example, due to the weight of the vehicle) at the tread 110 on the outer circumferences of the parabolic discs 102 and 104. This example depicts the deformation of the parabolic discs 102 and 104 parallel to the axis of rotation ‘R’, and the conformal deformation in contact with the ground. As shown in FIG. 2B, the static load is supported by the bands of treads 110 on the outer circumferences of the parabolic discs 102 and 104 in the non-pneumatic support structure 100. Furthermore, FIG. 2C illustrates an exemplary embodiment of the two-disc non-pneumatic support structure 100 under load plus shear. This example depicts the deformation of the parabolic discs 102 and 104 parallel to the axis of rotation ‘R’, and the conformal deformation in contact with the ground. As shown in FIG. 2C, the load is supported by the bands of treads 110 on the outer circumference of the parabolic discs 102 and 104 in the non-pneumatic support structure 100 and additional tread 112 proximal to the axis of rotation ‘R’. That is, under static load only the treads 110 on circumferential bands of the convex sides of the respective parabolic discs 102 and 104 are in contact with the driving surface; and under shear, the parabolic discs 102 and 104 deform laterally which places the additional treads 112 in contact with the driving surface.

In other words, the parabolic discs 102 and 104 of the non-pneumatic support structure 100 are designed to deform primarily parallel to the axis of rotation ‘R’ with the ground such that the static load is supported by a band of tread 110 on the outer circumference of the parabolic discs 102 and 104, and the additional tread 112 proximal to the axis of rotation ‘R’ under load and shear. Further, the parabolic discs 102 and 104 are fabricated to provide the required stiffness to resist collapse under the fractional weight of the vehicle supported by the wheel under conditions of maximum shear. The ground-contacting tread 110 on the convex side of the parabola of the parabolic discs 102 and 104 are located such that the area of the tread in contact with the ground is sufficient to carry the static and dynamic loads without exceeding the pressure and shear strength of the parabolic discs 102 and 104 and the tread 110, in the non-pneumatic support structure 100.

FIG. 3 illustrates a schematic perspective side view of an exemplary embodiment of a tire and wheel assembly 300 incorporating the two-disc non-pneumatic support structure 100, in accordance with embodiments of the present disclosure. Herein, the tire and wheel assembly 300 is an unloaded integrated two-disc non-pneumatic wheel assembly to be employed in a vehicle. The wheel assembly 300 includes a rim 302. As illustrated, the wheel assembly 300 is implemented as one piece in which the rim 302 and the parabolic discs 102 and 104 are formed as one integrated indivisible body adapted to mount on an axle hub 309 and secured conventionally for example with lug nuts 310. The parabolic discs 102 and 104 replace the rim flanges of a conventional pneumatic wheel to form the left and right sides of the wheel assembly 300. In the illustrated example, the parabolic discs 102 and 104 are arranged with their convex sides facing inward containing tread 110 and 112 (illustrated) and concave sides facing outward. This arrangement assures that the parabolic discs 102 and 104 may deform laterally without mutual interference. Further, the parabolic discs 102 and 104 project from the lateral edges of the wheel assembly 300. While that is the most conventional in appearance, it is not limiting to the present disclosure. In the present embodiments of the non-pneumatic support structure 100 and the wheel assembly 300, a person skilled in the art may choose the separation of the parabolic discs 102 and 104 and their position with respect to the faces of the wheel assembly 300 to meet the performance requirements of the intended application therefrom.

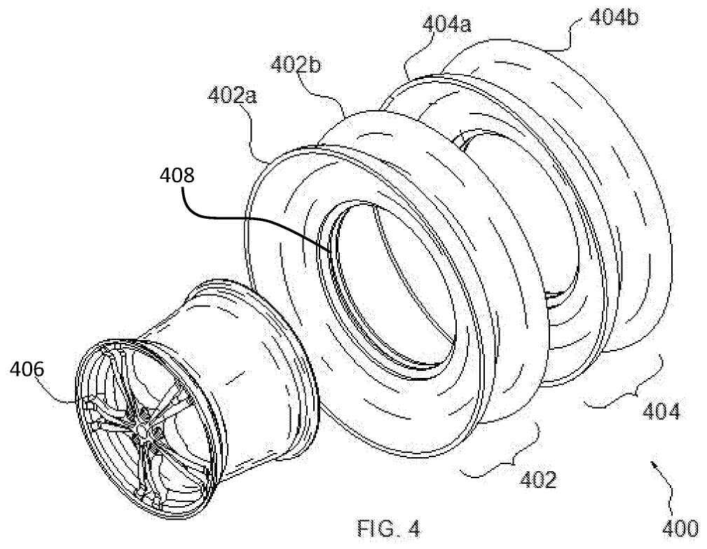

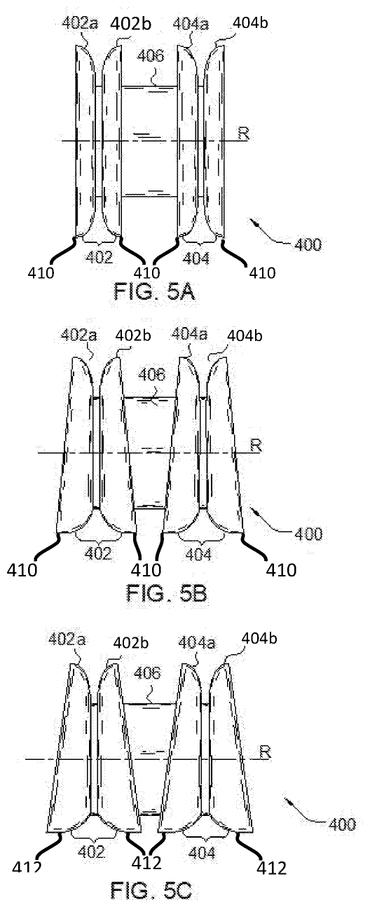

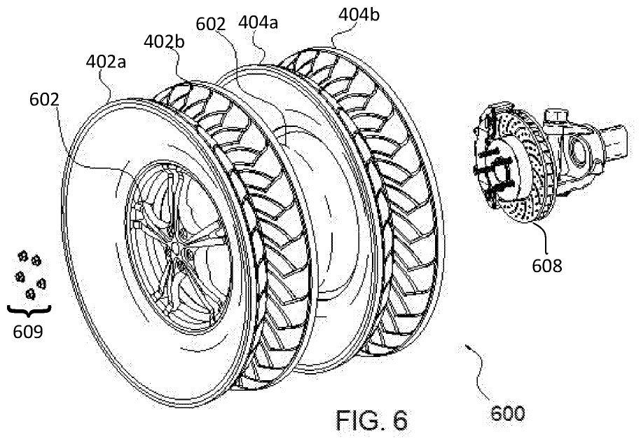

FIG. 4 illustrates a schematic perspective side view of an exemplary embodiment of an unloaded four-disc non-pneumatic support structure (generally designated by the numeral 400), in accordance with one or more embodiments of the present disclosure. Similar to the non-pneumatic support structure 100 (as illustrated in FIG. 1), the non-pneumatic support structure 400 is implemented for mounting on a conventional wheel fabricated for pneumatic tires. As illustrated in FIG. 4, the non-pneumatic support structure 400 includes two pairs of parabolic discs, a first pair of parabolic discs 402 with a first parabolic disc 402a and a second parabolic disc 402b, and a second pair of parabolic discs 404 with a first parabolic disc 404a and a second parabolic disc 404b. The non-pneumatic support structure 400 further includes a circular hole 408 sized appropriately to allow installation thereof on a wheel 406. In the exemplary embodiment shown in FIG. 4, disks 402a and 402b are joined as an indivisible unit 402, and disks 404a and 404b are joined as an indivisible unit 404. The parabolic disk pairs 402 and 404 are joined by installation on the wheel 406. The parabolic disk pairs 402 and 404 may be secured to the wheel using an adhesive, a slotted mating surface that grips both sides of the wheel flanges tightly by compressive tension, an expanded bead similar to current pneumatic tire beads or any other method alone or in combination with the aforementioned that provides sufficient strength and support. In the non-pneumatic support structure 400 (incorporating the non-pneumatic support structure 400), any load is supported by bands of ground contacting treads 410 (as properly shown and labelled in FIGS. 5A-5C and FIG. 6) on outer circumferences of the pairs of parabolic discs 402 and 404. The design, arrangement, characteristics and properties of the components of the four-disc non-pneumatic support structure 400 are similar to that of the two-disc non-pneumatic support structure 100 (as disclosed in the preceding paragraphs), and thus have not been repeated and are incorporated herein for the brevity of the present disclosure.

FIGS. 5A-5C are schematic front planar views of the four-disc non-pneumatic support structure 400 (as shown in FIG. 4) under increasing load conditions, from FIG. 5A to FIG. 5C, in accordance with exemplary embodiments of the present disclosure. Herein, the non-pneumatic support structure 400 is adapted to rotate about an axis of rotation ‘R’ (as shown by a dashed line). The illustrated views show an example parabolic contour of the parabolic discs 402a, 402b, 404a and 404b in increasing deformation parallel to the axis of rotation ‘R’. As discussed and shown herein, in the non-pneumatic support structure 400, the parabolic discs 402a, 402b, 404a and 404b are arranged in joined pairs of parabolic discs 402 and 404 to form the left and right sides of the non-pneumatic support structure 400, extending from the wheel to the ground with the convex sides facing thereto. However, while this arrangement assures that the pairs of parabolic discs 402 and 404 may deform laterally without mutual interference, it may not be limiting to the present disclosure. In the present embodiments, a person skilled in the art may choose any suitable permutation of joined-separated and concave-convex orientation of multiple parabolic discs to meet the requirements of the application.

In particular, FIG. 5A illustrates an exemplary embodiment of the four-disc non-pneumatic support structure 400 in an unloaded condition. As depicted, the parabolic contour of the parabolic discs 402a, 402b, 404a and 404b is generally maintained with minimal deformation (for example, due to the weight of the vehicle) at the tread 410 on the outer circumferences of the parabolic discs 402a, 402b, 404a and 404b. Further, FIG. 5B illustrates an exemplary embodiment of the four-disc non-pneumatic support structure 400 under static load. This example depicts the deformation of the parabolic discs 402a, 402b, 404a and 404b parallel to the axis of rotation ‘R’, and the conformal deformation in contact with the ground. As shown in FIG. 5B, the static load is supported by the bands of treads 410 on the outer circumferences of the parabolic discs 402a, 402b, 404a and 404b in the non-pneumatic support structure 400. Furthermore, FIG. 5C illustrates an exemplary embodiment of the four-disc non-pneumatic support structure 400 under load plus shear. This example depicts the deformation of the parabolic discs 402a, 402b, 404a and 404b parallel to the axis of rotation ‘R’, and the conformal deformation in contact with the ground. As shown in FIG. 5C, the load is supported by the bands of treads 410 on the outer circumference of the parabolic discs 402a, 402b, 404a and 404b in the non-pneumatic support structure 400 and additional tread 412 proximal to the axis of rotation ‘R’.

FIG. 6 illustrates a schematic perspective side view of an exemplary embodiment of an indivisible tire and wheel assembly 600 incorporating the four-disc non-pneumatic support structure 400, in accordance with embodiments of the present disclosure. Herein, the tire and wheel assembly 600 is an unloaded integrated four-disc non-pneumatic tire and wheel assembly adapted to be mounted on a vehicle hub 608 and secured conventionally for example with lug nuts 609. The tire and wheel assembly 600 includes a rim 602. As illustrated, the wheel assembly 600 is implemented as a one piece in which a wheel/rim 602 and the non-pneumatic support structure consisting of pairs of parabolic discs 402 and 404 (with the parabolic discs 402a, 402b, 404a and 404b) are formed as one indivisible body. The pairs of parabolic discs 402 and 404 form the left and right sides of the wheel assembly 600. In the illustrated example, the parabolic discs 402a, 402b, 404a and 404b are arranged with their convex sides facing opposed and concave sides facing away. This arrangement assures that the parabolic discs 402a, 402b, 404a and 404b may deform laterally without mutual interference. Further, the parabolic discs 402a, 402b, 404a and 404b project from the lateral edges of the wheel assembly 600. While that is the most conventional in appearance, it is not limiting to the present disclosure. In the present embodiments of the non-pneumatic support structure 400 and the wheel assembly 600, a person skilled in the art may choose the separation of the pairs of parabolic discs 402 and 404 (and the parabolic discs 402a, 402b, 404a and 404b therein) and their position with respect to the faces of the wheel assembly 600 to meet the performance requirements of the intended application therefrom.

In the present embodiments, the non-pneumatic support structure (such as, the non-pneumatic support structure 100) with two parabolic discs could be manufactured in a manner similar to the multi-step spindle drum assembly method currently used to manufacture pneumatic tires. The discs of the non-pneumatic support structure with bead perform the same function as a pneumatic tire sidewall without the benefit of the stiffening effect of internal air pressure. Consequently, the disc layup requires stiffening and reinforcement compared to pneumatic sidewalls to create a structure with the anisotropy, strength and flexural modulus required to support a vehicle and deflect parallel to the axis of rotation in response to load impact and shear. The annular tread of a toroidal tire is moved to the convex (interior) surface of the discs. The air bladder of a pneumatic tire is omitted. The inflation and shape curing process used in pneumatic tires may be modified to accommodate the open circumferential structure and convex-side tread. Similarly, the non-pneumatic support structure (such as, the non-pneumatic support structure 400) with four parabolic discs could be manufactured by bonding two two-disc non-pneumatic support structures (for example, two non-pneumatic support structures 400) together. Further, a non-pneumatic tire and wheel assembly, according to the present disclosure, could be manufactured as a single layup prior to curing, or as two cured structures bonded together at the discretion of the manufacturer.

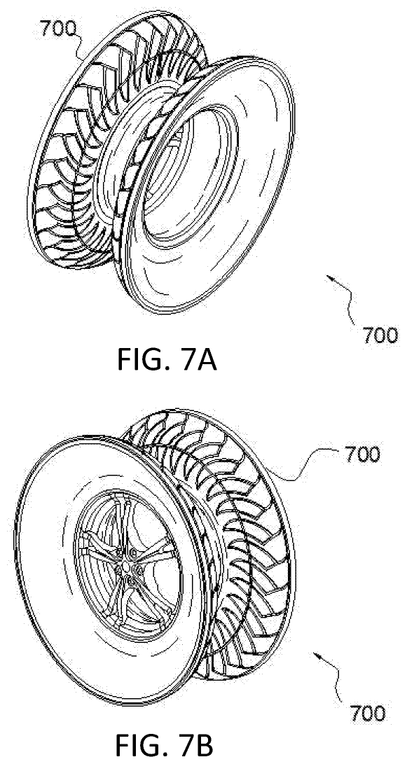

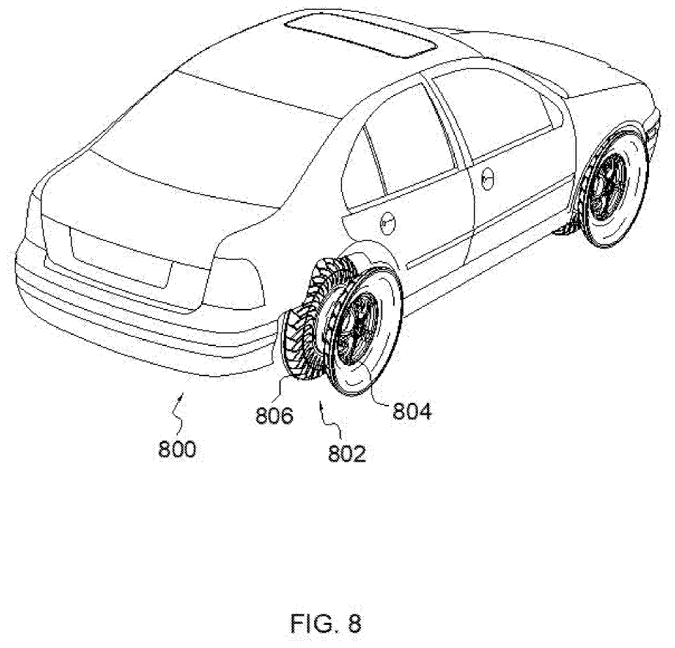

FIG. 7 illustrates diagrammatic perspective side views of a tire and wheel assembly 700 incorporating a two-disc non-pneumatic support structure, in accordance with one or more embodiments of the present disclosure. The tire and wheel assembly 700 includes tread 702 installed on the convex side of each parabolic disc thereof. As discussed, the tire and wheel assembly 700 may be suitable for direct installation on an axle hub (not shown) of a vehicle (not shown). FIG. 8 illustrates a partial diagrammatic perspective side view of a vehicle 800 non-pneumatic tire 802 incorporating a two-disc non-pneumatic support structure 100 installed on a rim 804 in the right-rear and right-front side of the vehicle 800, with tread 806 shown on the exposed convex side of left parabolic disc thereof, in accordance with one or more embodiments of the present disclosure. Herein, the parabolic discs of the non-pneumatic tire 802 are adapted for installation on the rim 804 of a wheel of the vehicle 800.

It may be appreciated by a person skilled in the art that automotive wheels or rims for vehicles, such as cars and light trucks, commonly range in size from 14 inches (35 cm) to 20 inches (51 cm). Herein, the size of the rim refers to the diameter of the rim flange which is in contact with the “bead” of a mounted tire. The tire bead and rim flange form the air-tight seal that allows pneumatic tires to remain pressurized. In case of the present non-pneumatic support structure (such as, the non-pneumatic support structure 100) for retro-fitting onto conventional wheels, an internal diameter of the parabolic discs 102 and 104 would be required to conform to the same dimensions as the conventional tire it would replace, which is commonly between 14 inches (35 cm) and 20 inches (51 cm). Further, an outer diameter of the parabolic discs 102 and 104 of the unloaded non-pneumatic support structure 100 would vary according to the application and performance requirements, generally increasing in proportion with increasing static weight of the vehicle and increasing wheel size. Quantitatively, the said outer diameter of an unloaded non-pneumatic support structure would typically vary from a minimum of approximately 24 inches (61 cm) for a 14-inch wheel to a maximum of 38 inches (99 cm) for a 20-inch wheel. Hereafter all outer diameters refer to non-pneumatic support structures in an unloaded condition. Similarly, wheels for medium, heavy and super-heavy trucks range from 22.5 inches (57 cm) for medium trucks to 63 inches (161 cm) for super-heavy (construction/mining) trucks. The two, three, or four parabolic discs of the non-pneumatic support structure (such as, the non-pneumatic support structure 400) to be retrofitted for trucks would vary over the same range. For example, the outer diameter for a 22.5-inch tire would range from approximately 34.5 inches (88 cm) to 40.5 inches (103 cm), and the outer diameter for a 63-inch tire would range from approximately 145 inches (370 cm) to 157 inches to (400 cm). Further, the spacing of the parabolic discs 102 and 104 on the rim is determined by the width of the rim flange to flange. For cars and light trucks, rims typically measure from 8 inches (20 cm) to 12 inches (31 cm) flange-to-flange which would require the compressible sleeve 106 connecting the parabolic discs 102 and 104 of a retrofit non-pneumatic tire (incorporating the non-pneumatic support structure 100) to adjust to a range of wheel widths. Typical wheel widths (measured from rim flange to rim flange) for trucks range from 10 inches (26 cm) to 59 inches (150 cm) depending upon the wheel size and gross vehicle weight of the truck. Therefore, a non-pneumatic support structure tire and wheel assembly would conceptually replace the separate wheel and tire with a similarly dimensioned assembly.

The embodiments illustrated and described herein as well as embodiments not specifically described herein but within the scope of aspects of the invention constitute non-pneumatic tires structures, and tire and/or wheel assemblies incorporating such non-pneumatic tires structures. The tires and wheel assemblies of the present disclosure may incorporate one or more parabolic discs for various possible variations, such as, but not limited to, a two-disc non-pneumatic support structure 100, a two-disc non-pneumatic tire and wheel assembly 300, a four-disc non-pneumatic support structure 400, a four-disc non-pneumatic tire and wheel assembly 600. It may be appreciated that the design employing two parabolic discs may be adequate for passenger cars and light trucks, and the design employing four (or more) parabolic discs may be preferable for medium and heavy trucks. The tire and/or wheel assemblies in various embodiments for a vehicle in accordance with the present invention includes one or more elastic anisotropic parabolic discs extending from wheel rim or hub and a ground-contacting tread on the convex side. The parabolic discs are fabricated with sufficient strength and stiffness to support a static load on their outer circumference within design limits but deflect parallel to the axis of rotation under increased load or shear to place additional tread in contact with the ground.

The non-pneumatic support structure 100; 400 of the present disclosure incorporates a non-toroidal morphology incorporating one or more parabolic discs with load-bearing radial tread surfaces. The non-pneumatic support structure 100; 400 of the present disclosure addresses a major disadvantage of pneumatic tires by eliminating the requirement for careful maintenance of inflation pressure. The present non-pneumatic support structure 100; 400 has advantages with respect to the toroidal tires in which rolling resistance varies proportionally with cushioning due to elastic deformation generally in the direction perpendicular to the axis of rotation, the entire annular tread is exposed to wear regardless of driving condition, the planar tread patch's rectangular planar face and inclined leading edge is prone to aquaplaning on thin films of water on the road surface, and protrusions in the road surface in contact with the tire induce a vertical impulse transmitted to the entire tire and wheel. The present non-pneumatic support structure 100; 400 may be formulated to eliminate, at least substantially, all the above described issues. That is, the present non-pneumatic support structure 100; 400 has an advantage of decreased rolling resistance and increased resistance to wear without compromising traction. Also, the present non-pneumatic support structure 100; 400 has an advantage by relaxing the constraint on the size of the tread area in contact with the ground under varying shear conditions. Further, the present non-pneumatic support structure 100; 400, by presenting one or more tread patches with a narrow leading edge, has an advantage of improved resistance to aquaplaning without compromising traction on dry surfaces. Furthermore, the present non-pneumatic support structure 100; 400 has an advantage of improved response to uneven surfaces by utilizing multiple semi-independent load-bearing surfaces that elastically deform substantially in the direction parallel to the axis of rotation. Furthermore, the present non-pneumatic support structure 100; 400 has an advantage of applying larger tread patches and improved traction under conditions of high shear without increasing rolling resistance under conditions of low shear.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A non-pneumatic support structure, comprising one or more anisotropic parabolic discs wherein the flexural modulus of the one or more anisotropic parabolic discs is configured such that elastic deformation parallel to the axis of symmetry is substantially favored over deformation perpendicular to the axis of symmetry.

2. A non-pneumatic tire adapted for attachment to a vehicle wheel incorporating the non-pneumatic support structure as claimed in claim 1 to support a vehicle with the axis of rotation collinear with the parabolic axis or axes of symmetry comprising:
a ground contacting radial tread applied to the convex side of each of the one or more anisotropic parabolic discs,
wherein the one or more anisotropic parabolic discs are configured to allow deformation parallel to an axis of rotation of the wheel with the ground, to substantially favor lateral deformation over radial deformation of the one or more anisotropic parabolic discs in response to load, impact or shear,
wherein a flexural modulus of the one or more anisotropic parabolic discs is configured such that elastic deformation parallel to the axis of rotation of the wheel with the ground is substantially favored over deformation perpendicular to the axis of rotation and is configured with sufficient flexural modulus parallel to the axis of rotation to support the static load of a vehicle with a circumferential band of the radial tread,
wherein a flexural modulus of the one or more anisotropic parabolic discs is configured to substantially favor lateral deformation over radial deformation of the outer circumference of the one or more anisotropic parabolic discs and is configured to deform laterally in response to load, impact or shear to place tread proximal to the axis of rotation in contact with the ground thereby to increase the area of the tread in contact with the ground.

3. A non-pneumatic vehicle wheel adapted for attachment to a vehicle axle hub incorporating the non-pneumatic support structure as claimed in claim 1 to support a vehicle with the axis of rotation collinear with the parabolic axis or axes of symmetry comprising:
a ground contacting radial tread applied to the convex side of each of the one or more anisotropic parabolic discs,
wherein the one or more anisotropic parabolic discs are configured to allow deformation parallel to an axis of rotation of the wheel with the ground, and to substantially favor lateral deformation over radial deformation of the one or more anisotropic parabolic discs in response to load, impact or shear,
wherein the one or more anisotropic parabolic discs are adapted to be suitable to be incorporated into an indivisible non-pneumatic tire and wheel assembly to support a vehicle axle hub thereon,
wherein a flexural modulus of the one or more anisotropic parabolic discs is configured such that elastic deformation parallel to the axis of rotation of the wheel with the ground is substantially favored over deformation perpendicular to the axis of rotation with the and is configured with sufficient flexural modulus parallel to the axis of rotation to support the static load of a vehicle with a circumferential band of the radial tread,
wherein the flexural modulus of the one or more anisotropic parabolic discs is configured to substantially favor lateral deformation over radial deformation of the outer circumference of the one or more anisotropic parabolic discs and is configured to deform laterally in response to load, impact or shear to place tread proximal to the axis of rotation in contact with the ground thereby to increase the area of the tread in contact with the ground.
